(19) United States
(12) Patent Application Publication
(10) Pub. No.: US 2015/0137691 A1
(43) Pub. Date: May 21, 2015

(54) HALF-BRIDGE INVERTER, ELECTRONIC BALLAST AND LIGHTING DEVICE WITH THE HALF-BRIDGE INVERTER

(71) Applicant: General Electric Company, Schenectady, NY (US)

(72) Inventors: Chenghua ZHU, Pudong (CN); Kai ZHUANG, Shanghai (CN); Bing ZHANG, Shanghai (CN)

(21) Appl. No.: 14/541,479

(22) Filed: Nov. 14, 2014

(30) Foreign Application Priority Data
Nov. 15, 2013 (CN) 201310573346.6

(51) Int. Cl. H02M 7/5387; H02M 5/458; H05B 37/02; H02M 1/36

(52) U.S. Cl. CPC H02M 7/5387; H02M 1/36; H02M 5/458; H05B 37/0209
USPC 315/200 R; 363/49; 363/34

(57) ABSTRACT

The invention discloses a half-bridge inverter which includes first and second inverter input terminals for receiving a direct current (DC) voltage, first and second inverter switches, first and second drive circuits, and an inverter startup circuit. The first and second drive circuits are adapted to alternatively turn on and turn off the first and second inverter switches, which can convert the DC voltage to a high frequency alternating current (AC) voltage. The inverter startup circuit includes a capacitor, diode, and resistor. The capacitor and diode are connected in parallel and further electrically connected in a drive circuit in series. The resistor is electrically coupled to the first inverter input terminal and to the capacitor/diode parallel combination. The inverter startup circuit is used to trigger the first or second inverter switch. An electronic ballast containing the half-bridge inverter and a lighting device containing said electronic ballast are also disclosed.

### BACKGROUND OF THE INVENTION

The invention relates to lighting technologies. More specifically, the invention relates to a half-bridge inverter having a novel inverter startup circuit, an electronic ballast with the half-bridge inverter, and a lighting device with the electronic ballast.

Lighting devices, such as gas discharge lamps and light emitting diodes (LEDs), can convert electric energy to light energy. An electronic ballast, which is used to provide power supply in a lighting device, comprises a half-bridge inverter for converting a direct current (DC) voltage to an alternating current (AC) voltage. The half-bridge inverter comprises an inverter startup circuit. As an essential component of the half-bridge inverter, the inverter startup circuit is adapted to initiate the self-oscillation operation of the half-bridge inverter.

The structure and operation of a bidirectional trigger diode based inverter startup circuit are known to skilled people in the power supply field. FIG. 1 shows a traditional electronic ballast 10 according to a prior-art, which comprises a rectification circuit 100, a half-bridge inverter 200, and a resonant output circuit 300. The half-bridge inverter 200 comprises a startup circuit including a first resistor 210, a second resistor 212, a diode 214, a bidirectional trigger diode 216 and a capacitor 218. The working principle of the half-bridge inverter 200 is described as follows. The inverter input terminals 202, 204 receive a DC voltage. The DC current flows through the resistors 210, 212, and the capacitor 218 is charged. When the voltage on the capacitor 218 reaches a threshold voltage of the bidirectional trigger diode 216, the bidirectional trigger diode 216 is triggered. The capacitor 218 discharges to the base pole 254 of the inverter switch 252, and the inverter switch 252 is triggered to be turned on. Once the inverter switch 252 is turned on, the driving signals provided by a base drive transformer will alternatively turn on and turn off the two inverter switches 232, 252. The base drive transformer includes a primary winding 320 and two secondary windings 230, 250. When the half-bridge inverter 200 is in operation, the capacitor 218 discharges to the diode 214 to avoid repetitive triggers of the bidirectional trigger diode 216.

The startup circuit of the traditional half-bridge inverter described above comprises many components including a high cost bidirectional trigger diode which is not stable in certain temperature ranges. So the traditional half-bridge inverter has problems of high cost and low reliability. Therefore, it is desirable to have a half-bridge inverter including a novel startup circuit which has simple structure, low cost, high reliability, and without utilizing a voltage breakdown device, such as the bidirectional trigger diode.

### SUMMARY OF THE INVENTION

The present invention provides a half-bridge inverter with a novel startup circuit, an electronic ballast including the half-bridge inverter, and a lighting device including the electronic ballast. The half-bridge inverter with a startup circuit of the present invention has a simple structure and high reliability.

The half-bridge inverter of the invention includes a first and a second inverter input terminals, a first and a second inverter output terminals, a first and a second inverter switches, a first and a second drive circuits and an inverter startup circuit. Comparing with the prior art described in background, the inverter startup circuit of the invention provides lower cost and higher reliability for the corresponding half-bridge inverter, electronic ballast, and lighting device.

The first and the second inverter input terminals are adapted to receive a DC voltage. The first and the second inverter output terminals are adapted to output a high frequency AC voltage.

The first and the second inverter switches are power switching devices, such as NPN transistor, Metal-Oxide-Semiconductor Field-Effect Transistor (MOSFET) and Insulated Gate Bipolar Transistor (IGBT). The first and the second inverter switches are turned on and turned off alternatively to convert the DC voltage to high frequency AC voltage.

In some embodiments, the first and the second drive circuits are electrically coupled to the first and the second inverter switches respectively, adapted to provide a first and a second driving signal respectively to alternatively turn on and turn off the first and the second inverter switches. The first and the second drive circuits are self-excited oscillation circuits or forced oscillation circuits. When they are self-excited oscillation circuits, the first drive circuit includes a first drive winding and a first drive resistor which is connected with the first drive winding in series, and the second drive circuit includes a second drive winding and a second drive resistor which is connected with the second drive winding in series. The said first or second drive resistor comprises one resistor or multiple resistors. When multiple resistors are used in the first or second drive circuit, the working frequency fine-tuning of the half-bridge inverter can be achieved. The multiple resistors can also take protective action in response to overload.

In some embodiments, the inverter startup circuit includes a first diode, a first capacitor and a first resistor. There is no voltage breakdown device, such as a bidirectional trigger diode, used in the inverter startup circuit. The first diode and the first capacitor are connected in parallel, forming a first parallel combination. The first parallel combination is electrically connected in the first or the second drive circuit in series. The first resistor has one end electrically coupled to the first inverter input terminal and the other end electrically coupled to the first parallel combination. The inverter startup circuit provides a starting voltage to trigger the first or the second inverter switch which is electrically coupled with the first parallel combination, and then to start the self-oscillation operation of the half-bridge inverter. The working principle of the inverter startup circuit is described as follows. The first and the second inverter input terminals receive a DC voltage. The DC current flows through the first resistor, and the first capacitor is charged. When the voltage on the first capacitor is high enough, an initial base current is produced and a positive feedback is quickly formed, then the inverter switch which is electrically coupled with the first parallel combination is triggered to be turned on. Once the first or the second inverter switch is turned on, the driving signals produced by the first and the second drive circuits will alternatively turn on and turn off the first and the second inverter switches. The first diode which is connected with the first capacitor in parallel is used to short the first capacitor during normal operation of the half-bridge inverter. The existence of the first capacitor will not affect the operation of drive circuit to which the first capacitor is coupled, to ensure the driving signals produced by the first and the second drive circuits are symmetric.

In some embodiments, when the half-bridge inverter is in operation, to avoid the inconsistence between the first and the second drive circuits caused by the inverter startup circuit, several designs can be employed to make the first and the second driving signals symmetric. One approach is to match the impedances in the first and the second drive circuits to get symmetric driving signals. The second approach is to add a second parallel combination in series connected in the first or the second drive circuit which is not electrically coupled to the first parallel combination. The second parallel combination includes a second diode and a second capacitor connected in parallel. Preferably, the second parallel combination has the same components and structure as the first parallel combination.

In some embodiments, an electronic ballast of the invention includes a rectification circuit and a half-bridge inverter as described above. The rectification circuit includes a first and a second rectification circuit input terminals which are adapted to receive an AC voltage, and a first and a second rectification circuit output terminals which are adapted to output a DC voltage. The first and the second rectification circuit output terminals are electrically coupled to the first and the second inverter input terminals of the half-bridge inverter respectively. In addition, the first resistor of the inverter startup circuit may have one end electrically coupled to one of the first inverter input terminal, the first rectification circuit input terminal and the second rectification circuit input terminal, and the other end electrically coupled to the first parallel combination.

A lighting device of the invention includes an electronic ballast as described above and a lamp load. The lamp load can be at least one gas discharge lamp or lamps of other types.

Since there is no voltage breakdown device used in the inverter startup circuit of the half-bridge inverter, comparing with the prior art shown in FIG. 1, the inverter, the electronic ballast, and the lighting device of the invention have simpler structures and higher reliability.

### BRIEF DESCRIPTION OF THE DRAWINGS

The above and other aspects, features, and advantages of the present invention will be described in more detail with reference made to the accompanying drawings, in which:

FIG. 1 shows a circuit diagram of a traditional electronic ballast and a lamp load;

FIG. 2 shows a circuit diagram of an electronic ballast and a lamp load according to a first embodiment of the invention;

FIG. 3 shows a circuit diagram of an electronic ballast and a lamp load according to a second embodiment of the invention;

FIG. 4 shows a circuit diagram of an electronic ballast and a lamp load according to a third embodiment of the invention;

FIG. 5 shows a circuit diagram of an electronic ballast and a lamp load according to a fourth embodiment of the invention.

### DETAILED DESCRIPTION OF THE INVENTION

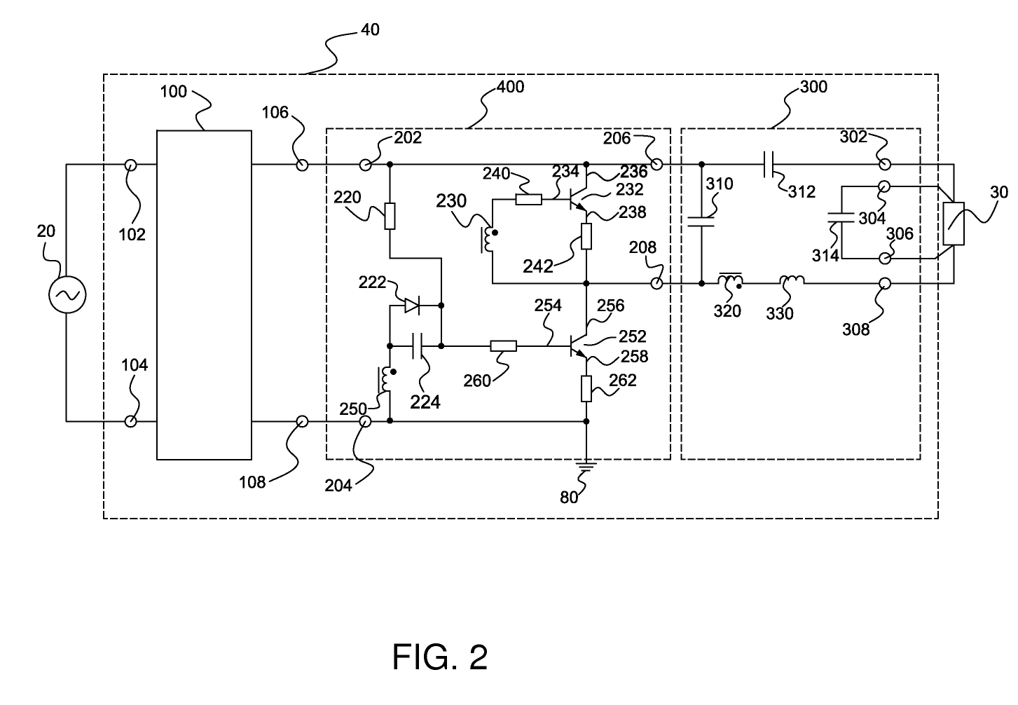

FIGS. 2-5 show the electronic ballast circuit diagrams 40, 50, 60, and 70 according to example embodiments of the invention. As shown in the drawings, the electronic ballast 40, 50, 60, or 70, which is adapted to supply power to a lamp load 30, includes a rectification circuit 100, a half-bridge inverter 400, 500, 600 or 700, and a resonant output circuit 300.

As one embodiment of the invention, the rectification circuit 100 comprises a full-wave rectification circuit, and optionally comprises a circuit for power factor correction. The rectification circuit 100 has two input terminals 102, 104 and two output terminals 106, 108. The input terminals 102, 104 are adapted to receive AC voltage from an AC voltage source 20. The output terminals 106, 108 are respectively electrically coupled to the first and the second inverter input terminals 202, 204 of the half-bridge inverter 400, 500, 600 and 700. During operation of the electronic ballast, the rectification circuit 100 receives AC voltage from the AC voltage source 20 and provides a DC voltage between its output terminals 106, 108.

The output resonant circuit 300 comprises a first, a second, a third and a fourth output terminals 302, 304, 306, 308, a series combination of a resonant inductor 330 and a primary winding of a base drive transformer 320, a resonant capacitor 314, and a blocking capacitor 312. The output terminals 302, 304, 306, 308 are electrically coupled to the lamp load 30. The series combination of the resonant inductor 330 and the primary winding 320 is electrically coupled between the second inverter output terminal 208 and the fourth output terminal 308 of the output resonant circuit 300. The primary winding 320 is magnetically coupled with the first and the second base drive windings 230, 250 of the half-bridge inverter 400, 500, 600 or 700, which are the secondary windings of the base drive transformer. The resonant capacitor 314 is electrically coupled between the second and the third output terminals 304, 306. The blocking capacitor 312 is electrically coupled between the first inverter output terminal 206 and the first output terminal 302. The resonant output circuit 300 provides igniting voltage and a steady-state power to the lamp load 30.

In addition, the lamp load 30 and the electronic ballast 40, 50, 60, or 70 which is used to supply power to the lamp load 30, may be two separate physical components, or may be integrated as a whole. The lamp load 30 comprises one or more gas discharge lamps, or lamps of other kinds

The half-bridge inverters 400, 500, 600, and 700 are described in detail separately as the first, the second, the third, and the fourth embodiment of the invention.

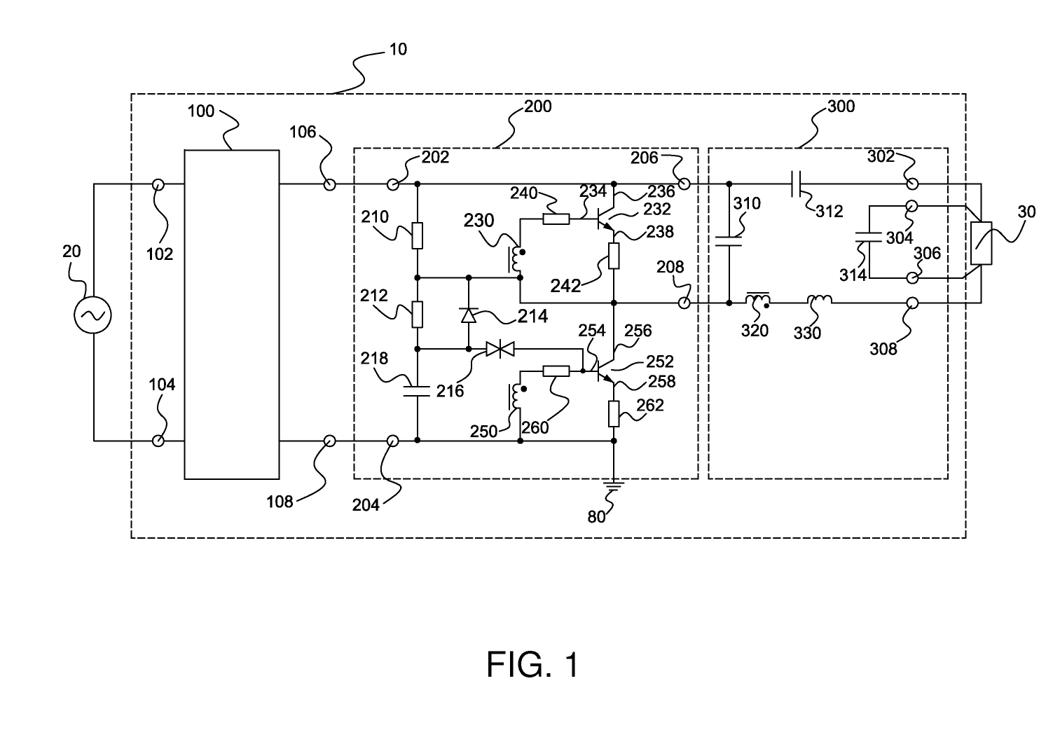

FIG. 2 shows a half-bridge inverter 400 according to a first embodiment of the invention. The half-bridge inverter 400 includes a first and a second inverter input terminals 202, 204, a first and a second inverter output terminals 206, 208, a first and a second inverter switches 232, 252, a first drive circuit 230, 240, a second drive circuit 250, 260, and an inverter startup circuit 220, 222, 224. Comparing with the traditional half-bridge inverter 200 shown in FIG. 1, the half-bridge inverter 400 has advantages of low cost and high reliability because of its novel startup circuit 220, 222, 224.

The first and the second inverter input terminals 202, 204 are adapted to receive a DC voltage. The first and the second inverter output terminals 206, 208 are adapted to output a high frequency AC voltage. The first inverter output terminal 206 is electrically coupled to the first inverter input terminal 202.

The first and the second inverter switches 232, 252 are power switching devices. In one embodiment, the first and the second inverter switches 232, 252 are both NPN transistors. The first inverter switch 232, which comprises a base terminal 234, a collector terminal 236 and an emitter terminal 238, is electrically coupled between the first inverter input terminal 202 and the second inverter output terminal 208. More specifically, the collector terminal 236 is electrically coupled to the first inverter input terminal 202, and the emitter terminal 238 is electrically coupled to the second inverter output terminal 208. The second inverter switch 252 which comprises a base terminal 254, a collector terminal 256 and an emitter terminal 258 is electrically coupled between the second inverter output terminal 208 and the second inverter input terminal 204. More specifically, the collector terminal 256 is electrically coupled to the second inverter output terminal 208, and the emitter terminal 258 is electrically coupled the second inverter input terminal 204. In FIG. 2, the ground 80 is a ground reference, which is electrically coupled to the second inverter input terminal 204.

The first drive circuit comprises a series combination of a first base drive winding 230 and a first drive resistor 240. The series combination 230, 240 is electrically coupled between the base terminal 234 and the emitter terminal 238 of the first inverter switch 232. The second drive circuit comprises a series combination of a second base drive winding 250 and a second drive resistor 260. The series combination 250, 260 is electrically coupled between the base terminal 254 and the emitter terminal 258 of the second inverter switch 252. As shown in FIG. 2, the first or the second drive circuit can further comprise one or more drive resistors, such as the drive resistor 242 in the first drive circuit, the drive resistor 262 in the second drive circuit. When multiple drive resistors are used in drive circuit, the working frequency fine-tuning of the half-bridge inverter can be achieved, and they can also take protective action in response to overload.

The inverter startup circuit includes a resistor 220, a diode 222, and a capacitor 224. There is no voltage breakdown device, such as a bidirectional trigger diode, included in the inverter startup circuit. The diode 222 and the capacitor 224 are connected in parallel forming a first parallel combination. The first parallel combination is electrically connected in the second drive circuit in series. The resistor 220 has one end electrically coupled to the first inverter input terminal 202 and the other end electrically coupled to the first parallel combination 222, 224. The startup circuit provides a starting voltage to trigger the second inverter switch 252, and then to start self-oscillation operation of the half-bridge inverter 400. The working principle of the inverter startup circuit 220, 222, 224 is described as follows. The inverter input terminals 202, 204 of the half-bridge inverter 400 receive a DC voltage. The DC current flows through the resistor 220 and the base drive winding 250. The capacitor 224 is charged. When the voltage on the capacitor 224 is high enough, an initial base current is produced and a positive feedback is quickly formed to turn on the second inverter switch 252. Once the inverter switch 252 is turned on, the driving signals will alternatively turn on and turn off of the first and the second inverter switches 232, 252. The driving signals are produced by base drive transformer which comprises a primary winding 320 and two secondary windings 230, 250. The diode 222 which is connected with the capacitor 224 in parallel is used to short the capacitor 224 during normal operation of the half-bridge inverter 400. So the existence of the capacitor 224 will not affect the second drive circuit, to ensure the driving signals produced by the first and the second drive circuits are symmetric. Comparing to the inverter startup circuit 210, 212, 214, 216, 218 of the traditional half-bridge inverter 200 shown in FIG. 1, the startup circuit 220, 222, 224 of the invention has simpler structure, lower cost, and higher reliability.

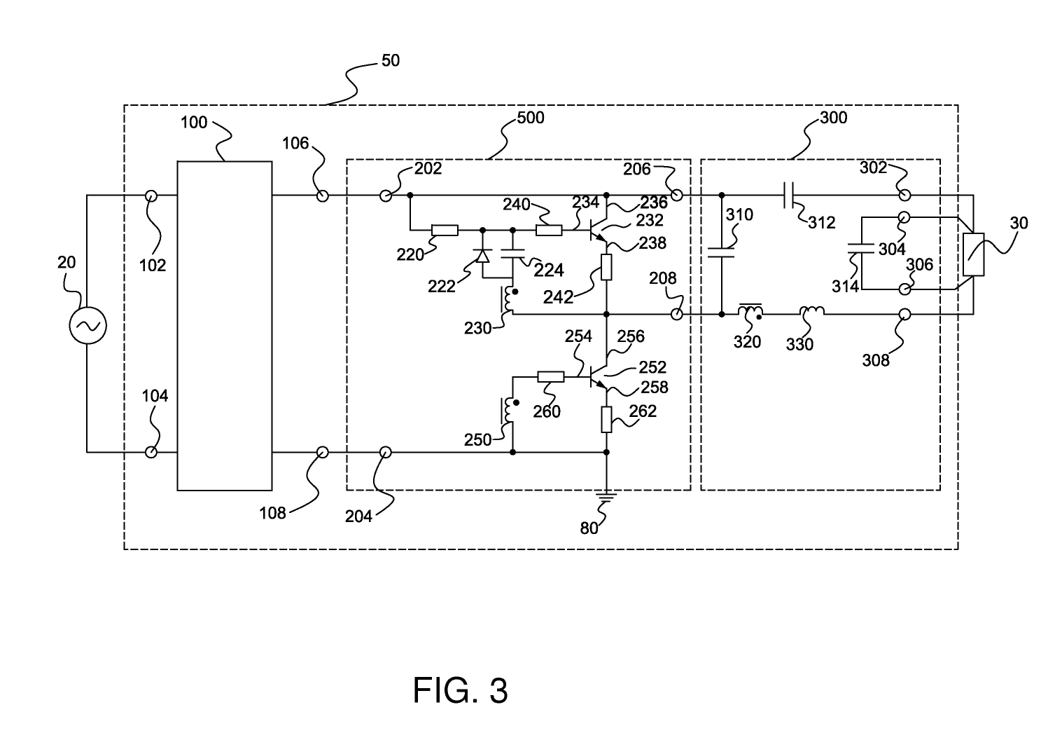

FIG. 3 shows a half-bridge inverter 500 according to a second embodiment of the invention. The half-bridge inverter 500 includes a first and a second inverter input terminal 202, 204, a first and a second inverter output terminal 206, 208, a first and a second inverter switch 232, 252, a first drive circuit 230, 240, and a second drive circuit 250, 260, which are substantially the same as the components in the half-bridge inverter 400 of the first embodiment. The half-bridge inverter 500 further includes an inverter startup circuit which comprises a resistor 220, a diode 222 and a capacitor 224. The diode 222 and the capacitor 224 are connected in parallel forming a first parallel combination. The first parallel combination 222, 224 is electrically coupled in the first drive circuit in series. The resistor 220 has one end electrically coupled to the first inverter input terminal 202 and the other end electrically coupled to the first parallel combination. The inverter startup circuit provides a starting voltage to trigger the first inverter switch 232, and then to start self-oscillation operation of the half-bridge inverter 500. The half-bridge inverter 500 described above is included in the electronic ballast 50 shown in FIG. 3.

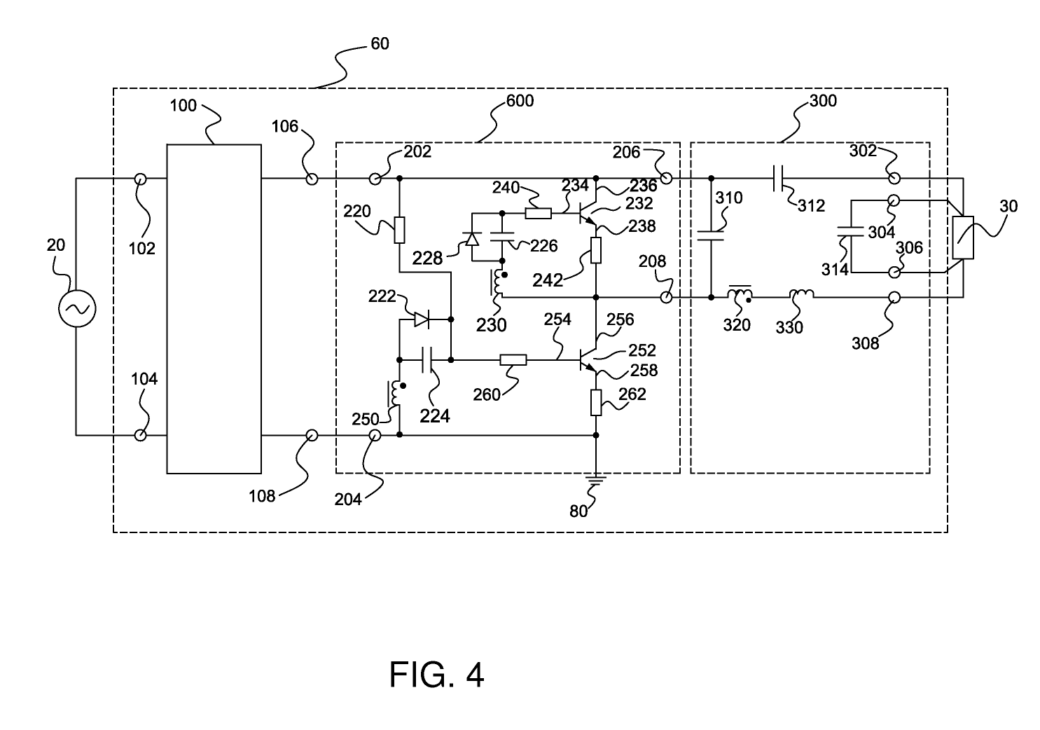

FIG. 4 shows a half-bridge inverter 600 according to a third embodiment of the invention. The half-bridge inverter 600 comprises a first and a second inverter input terminal 202, 204, a first and a second inverter output terminal 206, 208, a first and a second inverter switch 232, 252, a first drive circuit 230, 240, a second drive circuit 250, 260 and a startup circuit 220, 222, 224, which are substantially the same as the components in the half-bridge inverter 400 of the first embodiment. The half-bridge inverter 600 further comprises a second parallel combination of a capacitor 226 and a diode 228, which are connected in parallel. The second parallel combination 226, 228 is electrically coupled in the first drive circuit 230, 240 in series. The first and the second drive circuits are symmetric in structure, which can avoid inconsistency between the first and the second drive circuits caused by the existence of the inverter startup circuit during normal operation of the half-bridge inverter 600. The half-bridge inverter 600 described above is included in the electronic ballast 60 shown in FIG. 4.

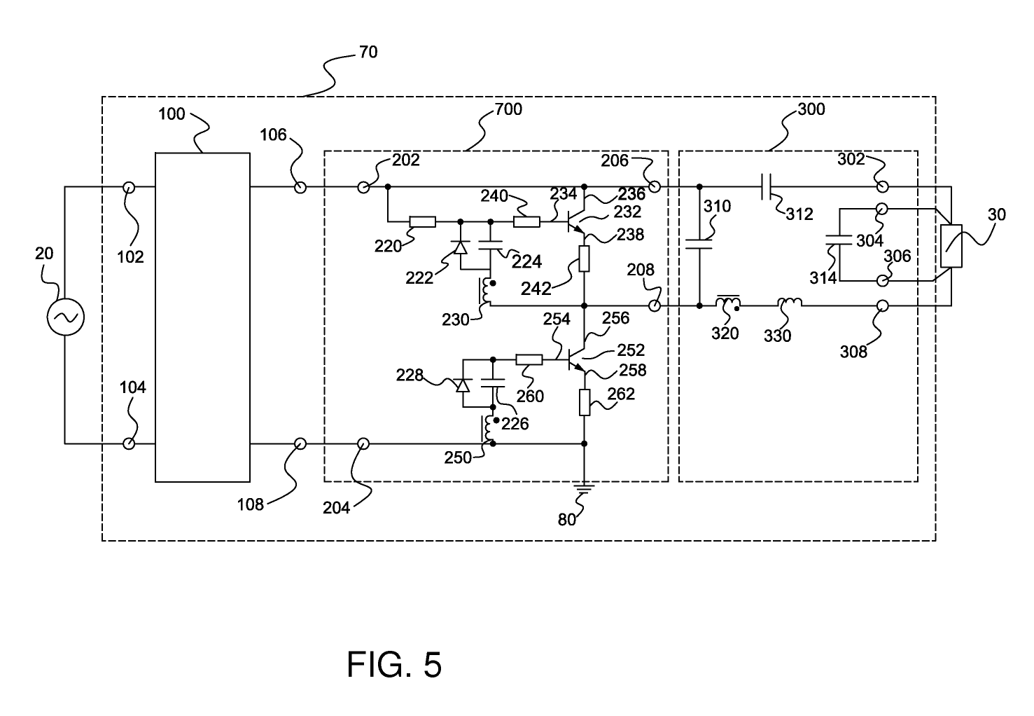

FIG. 5 shows a half-bridge inverter 700 according to the fourth embodiment of the invention. The half-bridge inverter 700 comprises a first and a second inverter input terminal 202, 204, a first and a second inverter output terminal 206, 208, a first and a second inverter switch 232, 252, a first drive circuit 230, 240, a second drive circuit 250, 260 and an inverter startup circuit 220, 222, 224, which are substantially the same as the components in the half-bridge inverter 500 of the second embodiment. The half-bridge inverter 700 further comprises a second parallel combination of a capacitor 226 and a diode 228. The second parallel combination 226, 228 is electrically coupled in the second drive circuit 250, 260 in series. The first and the second drive circuits are symmetric in structure, which can avoid inconsistency between the first and the second drive circuits caused by the existence of the startup circuit during normal operation of the half-bridge inverter 700. The half-bridge inverter 700 described above is included in the electronic ballast 70 shown in FIG. 5.

This written description uses examples to describe the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A half-bridge inverter, comprising:
a first and a second inverter input terminals for receiving a direct current (DC) voltage;
a first and a second inverter switches being electrically coupled between the first and the second inverter input terminals;
a first and a second drive circuits being electrically coupled to the first and the second inverter switches respectively, and providing a first and a second driving signals to alternatively turn on and turn off the first and the second inverter switches; and
an inverter startup circuit comprising a first parallel combination and a first resistor, the first parallel combination being electrically coupled to the first or the second drive circuit, the first parallel combination comprising a first capacitor and a first diode connected in parallel with the first capacitor, the first resistor having one end electrically coupled to the first inverter input terminal and the other end electrically coupled to the first parallel combination.

2. The half-bridge inverter of claim 1, wherein the first and the second driving signals respectively from the first and the second drive circuits are symmetric.

3. The half-bridge inverter of claim 2, wherein the first and the second drive circuits are impedance matching, so that the first and the second driving signals are symmetric.

4. The half-bridge inverter of claim 2, wherein one of the first and the second drive circuits, which is not electrically coupled to the first parallel combination, further comprises a second parallel combination of a second capacitor and a second diode connected in parallel with the second capacitor.

5. An electronic ballast, comprising:
a rectification circuit comprising a first and a second rectification circuit input terminals for receiving an alternating current (AC) voltage, and a first and a second rectification circuit output terminals to output a direct current (DC) voltage; and
a half-bridge inverter comprising:
a first and a second inverter input terminals being electrically coupled to the first and the second rectification circuit output terminals respectively for receiving the direct current (DC) voltage;
a first and a second inverter switches being electrically coupled between the first and the second inverter input terminals;
a first and a second drive circuits being electrically coupled to the first and the second inverter switches respectively, and providing a first and a second driving signals to alternatively turn on and turn off the first and the second inverter switches; and
an inverter startup circuit comprising a first parallel combination and a first resistor, the first parallel combination being electrically coupled to the first or the second drive circuit, the first parallel combination comprising a first capacitor and a first diode connected in parallel with the first capacitor, wherein the first resistor has one end electrically coupled to one of the first and the second rectification circuit input terminals or the first inverter input terminal, and the other end electrically coupled to the first parallel combination.

6. The electronic ballast of claim 5, wherein the first and the second driving signals respectively from the first and the second drive circuits are symmetric.

7. The electronic ballast of claim 6, wherein the first and the second drive circuits are impedance matching, so that the first and the second driving signals are symmetric.

8. The electronic ballast of claim 6, wherein one of the first and the second drive circuits, which is not electrically coupled to the first parallel combination, further comprises a second parallel combination of a second capacitor and a second diode connected in parallel with the second capacitor.

9. A lighting device, comprising an electronic ballast and a lamp load, the electronic ballast comprising:
a rectification circuit comprising a first and a second rectification circuit input terminals for receiving an alternating current (AC) voltage, and a first and a second rectification circuit output terminals to output a direct current (DC) voltage; and
a half-bridge inverter comprising:
a first and a second inverter input terminals being electrically coupled to the first and the second rectification circuit output terminals respectively for receiving the direct current (DC) voltage;
a first and a second inverter switches being electrically coupled between the first and the second inverter input terminals;
a first and a second drive circuits being electrically coupled to the first and the second inverter switches respectively, and providing a first and a second driving signals to alternatively turn on and turn off the first and the second inverter switches; and
an inverter startup circuit comprising a first parallel combination and a first resistor, the first parallel combination being electrically coupled to the first or the second drive circuit, the first parallel combination comprising a first capacitor and a first diode connected in parallel with the first capacitor, wherein the first resistor has one end electrically coupled to one of the first and the second rectification circuit input terminals or the first inverter input terminal, and the other end electrically coupled to the first parallel combination.

10. The lighting device of claim 9, wherein the first and the second driving signals respectively from the first and the second drive circuits are symmetric.

11. The lighting device of claim 10, wherein the first and the second drive circuits are impedance matching, so that the first and the second driving signals are symmetric.

12. The lighting device of claim 10, wherein one of the first and the second drive circuits, which is not electrically coupled to the first parallel combination, further comprises a second parallel combination of a second capacitor and a second diode connected in parallel with the second capacitor.
